(19) United States
(12) Patent Application Publication
(10) Pub. No.: US 2020/0048088 A1
(43) Pub. Date: Feb. 13, 2020

(54) METHOD AND SYSTEM FOR PRODUCING HYDROGEN USING AN OXYGEN TRANSPORT MEMBRANE BASED REFORMING SYSTEM

(71) Applicant: PRAXAIR TECHNOLOGY, INC., Danbury, CT (US)

(72) Inventors: Shrikar Chakravarti, East Amherst, NY (US); Ines C. Stuckert, Grand Island, NY (US)

(21) Appl. No.: 16/492,635

(22) PCT Filed: Mar. 12, 2018
(86) PCT No.: PCT/US2018/021961

§ 371 Date: Sep. 10, 2019

Related U.S. Application Data
(60) Provisional application No. 62/472,114, filed on Mar. 16, 2017.

(51) Int. Cl. C01B 3/48; C01B 3/38; C01B 3/56; B01D 53/22; B01D 53/047; C01B 13/02

(52) U.S. Cl. CPC C01B 3/48; C01B 3/384; C01B 3/56; B01D 53/229; B01D 53/047; C01B 13/0251; C01B 2203/127; C01B 2203/0233; C01B 2203/0283; C01B 2203/042; C01B 2203/0822; C01B 2203/0827; C01B 2203/1241; C01B 13/0237

(57) ABSTRACT

A method and system for producing hydrogen using an oxygen transport membrane based reforming system is disclosed. The system of the invention comprises at least two reactors in the form of sets of catalyst containing tubes:
a first set of tubes comprising at least one reforming catalyst containing reforming reactor configured to produce a synthesis gas stream, and
a second set of tubes comprising a reactively driven and catalyst containing oxygen transport membrane reactor configured to generate and radiate heat to the reforming reactor.

The synthesis gas product is further treated in a separate high temperature water gas shift reactor and optionally in a separate low temperature water gas shift reactor. Hydrogen is produced from the resulting hydrogen-enriched gas using hydrogen PSA. A distinctive feature of this OTM configuration is that no portion of the syngas is fed to the OTM reactor, which allows reforming to be conducted in the reforming reactors at much higher pressures. The synthesis gas stream is directed to the water gas shift (WGS) reactor where H2/CO ratio increases from about 4.7 to about 21. Since the WGS reaction is exothermic, the shifted syngas leaves the reactor at a higher temperature, typically about 410° C. This shifted syngas is used to heat the NG feedstock in the NG heater to about 370° C., and then used to preheat boiler feed water (BFW). Syngas leaving the BFW heater is at about 175° C. It is cooled down to about 40° C. in a syngas cooler fed by cooling water. The cooled syngas then enters a knock-out drum where water is removed from the bottoms as process condensate and recycled for use within the process.

### RELATED APPLICATIONS

This application claims the benefit of International Application No. PCT/US2018/021961, filed on Mar. 12, 2018, which claimed the benefit of U.S. Provisional Application Ser. No. 62/472,114, filed on Mar. 16, 2017, which are incorporated herein by reference.

### FIELD OF THE INVENTION

The present invention relates to a method and system for production of hydrogen utilizing an oxygen transport membrane based reforming system, water gas shift reactor and hydrogen PSA.

### BACKGROUND OF THE INVENTION

Synthesis gas containing hydrogen and carbon monoxide is used for a variety of industrial applications, for example, the production of hydrogen, chemicals and synthetic fuels. Conventionally, the synthesis gas is produced in a fired reformer in which natural gas and steam are reformed in nickel catalyst containing reformer tubes at high temperatures (e.g., 850° C. to 1000° C.) and moderate pressures (e.g., 16 to 30 bar) to produce the synthesis gas. The endothermic heating requirements for steam methane reforming reactions occurring within the reformer tubes are provided by burners firing into the furnace that are fueled by part of the natural gas. In order to increase the hydrogen content of the synthesis gas produced by the steam methane reforming (SMR) process, the synthesis gas can be subjected to water-gas shift reactions to react steam with the carbon monoxide in the synthesis gas. Typically hydrogen is recovered by treating the hydrogen rich stream in a H₂ PSA. The tail gas from the H₂ PSA is utilized as a fuel in the fired reformer to facilitate endothermic reforming reactions.

A well-established alternative to steam methane reforming is the non-catalytic partial oxidation process (POx) whereby a sub-stoichiometric amount of oxygen is allowed to react with the natural gas feed creating steam and carbon dioxide at high temperatures. The high temperature residual methane is reformed through reactions with the high temperature steam and carbon dioxide.

An attractive alternative process for producing synthesis gas is the autothermal reforming (ATR) process which uses oxidation to produce heat and a catalyst to permit reforming to occur at lower temperatures than the POx process. Similar to the POx process, oxygen is required to partially oxidize natural gas in a burner to provide heat, high temperature carbon dioxide and steam to reform the residual methane. Some steam needs to be added to the natural gas to control carbon formation on the catalyst. However, both the ATR and POx processes require separate air separation units (ASU) to produce high-pressure oxygen, which adds complexity as well as capital and operating costs to the overall process.

When the feedstock contains significant amounts of heavy hydrocarbons, SMR and ATR processes are typically preceded by a pre-reforming step. Pre-reforming is a catalyst based process for converting higher hydrocarbons to methane, hydrogen, carbon monoxide and carbon dioxide. The reactions involved in pre-reforming are generally endothermic. Most pre-reformers on natural gas streams operate in the endothermic area and operate adiabatically, and thus the pre-reformed feedstock leaves at a lower temperature than the feedstock entering the pre-reformer. Another process is the secondary or combined reforming process, which is essentially an autothermal process that is fed the product from a steam methane reforming process. Thus, the feed to a secondary reforming process is primarily synthesis gas from steam methane reforming. Depending on the end application, some natural gas may bypass the SMR process and be directly introduced into the secondary reforming step. Also, when a SMR process is followed by a secondary reforming process, the SMR may operate at a lower temperature, e.g. 650° C. to 825° C. versus 850° C. to 1000° C.

As can be appreciated, the conventional methods of producing a synthesis gas such as have been discussed above are expensive and require complex installations. To overcome the complexity and expense of such installations it has been proposed to generate the synthesis gas within reactors that utilize an oxygen transport membrane to supply oxygen and thereby generate the heat necessary to support endothermic heating requirements of the steam methane reforming reactions. A typical oxygen transport membrane has a dense layer that, while being impervious to air or other oxygen containing gas, will transport oxygen ions when subjected to an elevated operational temperature and a difference in oxygen partial pressure across the membrane.

Examples of oxygen transport membrane based reforming systems used in the production of synthesis gas can be found in U.S. Pat. Nos. 6,048,472; 6,110,979; 6,114,400; 6,296,686; 7,261,751; 8,262,755; and 8,419,827. There is an operational problem with all of these oxygen transport membrane based systems because such oxygen transport membranes need to operate at high temperatures of around 900° C. to 1100° C. When hydrocarbons such as methane and higher order hydrocarbons are subjected to such high temperatures within the oxygen transport membrane, excessive carbon formation occurs, especially at high pressures and low steam to carbon ratios. The carbon formation problems are particularly severe in the above-identified prior art oxygen transport membrane based systems. A different approach to using an oxygen transport membrane based reforming system in the production of synthesis gas is disclosed in U.S. Pat. No. 8,349,214 which provides an oxygen transport membrane based reforming system that uses hydrogen and carbon monoxide as part of the reactant gas feed to the oxygen transport membrane tubes and minimizes the hydrocarbon content of the feed entering the permeate side of the oxygen transport membrane tubes. Excess heat generated within the oxygen transport membrane tubes is transported mainly by radiation to the reforming tubes made of conventional materials. Use of high hydrogen and carbon monoxide in feed to the oxygen transport membrane tubes addresses many of the highlighted problems with the earlier oxygen transport membrane systems.

Other problems that arise with the prior art oxygen transport membrane based reforming systems are the cost of the oxygen transport membrane modules and the lower than desired durability, reliability and operating availability of such oxygen transport membrane based reforming systems. These problems are the primary reasons that oxygen transport membranes based reforming systems have not been successfully commercialized. Advances in oxygen transport membrane materials have addressed problems associated with oxygen flux, membrane degradation and creep life, but there is much work left to be done to achieve commercially viable oxygen transport membrane based reforming systems from a cost standpoint as well as from an operating reliability and availability standpoint. Also for hydrogen production additional challenges remain. Compared to conventional steam methane reformers, the oxygen transport membrane reforming systems mentioned above produce a synthesis gas containing lower amounts of hydrogen and higher amounts of carbon monoxide (lower hydrogen to carbon monoxide molar ratio); treating this synthesis gas in a hydrogen PSA results in a tail gas having more fuel value than can be directly utilized in the oxygen transport membrane based reforming system.

The present invention addresses the aforementioned problems by providing an improved process for high pressure synthesis gas and hydrogen production using a reactively-driven oxygen transport membrane based system, which comprises of two reactors that can be in the form of sets of catalyst containing tubes—reforming reactor and oxygen transport membrane reactor. Partial oxidation occurs at the permeate (i.e. catalyst containing) side of the oxygen transport membranes and a reforming process facilitated by a reforming catalyst occurs in the reforming reactor in close proximity to the oxygen transport membrane reactor. The partial oxidation process, which is exothermic, and the reforming process, which is endothermic, both occur within the oxygen transport membrane based reforming system and thus the reforming reactor and the oxygen transport membrane reactor have a high degree of thermal integration so that a major portion of the heat released in the oxidation process supplies the heat for the reforming process. Specifically, improvements to the reactively-driven oxygen transport membrane based system include: modifications to the reactively-driven oxygen transport membrane based system to carry out a reforming process in a catalyst filled reforming reactor, and thermal coupling of the reforming reactor with heat provided by the partial oxidation process in the oxygen transport membrane reactor.

A distinctive feature of the oxygen transport membrane based reforming system of the invention is that no portion of the synthesis gas product stream from the reforming reactor is fed to the oxygen transport membrane reactor. Consequently, the pressure of the synthesis gas product is not limited by the operating pressure of oxygen transport membrane reactor. Further improvements to obtain higher hydrogen recovery include subjecting the synthesis gas to water gas shift reactions in a high temperature or medium temperature shift reactor and optionally in a low temperature shift reactor.

### SUMMARY OF THE INVENTION

The present invention relates to a method and system for producing hydrogen utilizing an oxygen transport membrane based reforming system. The system of the invention comprises at least two reactors in the form of sets of catalyst containing tubes:
a first set of tubes comprising at least one reforming catalyst containing reforming reactor configured to produce a synthesis gas stream, and
a second set of tubes comprising a reactively driven and catalyst containing oxygen transport membrane reactor configured to generate and radiate heat to the reforming reactor.
   The method of the invention comprises:

separating oxygen from an oxygen containing stream with one or more oxidation catalyst containing oxygen transport membrane reactors to produce an oxygen permeate and an oxygen depleted retentate stream, the catalyst being contained within tubes on the permeate side of the oxygen transport membrane reactors;

feeding a fuel gas stream to a permeate side of the oxygen transport membrane elements and reacting same with the oxygen permeate to generate a reaction product stream and heat;

transferring the heat via convection to the oxygen depleted retentate stream and via radiation to said at least one catalyst containing reforming reactor;

reforming a combined feed stream comprising natural gas and steam in said at least one reforming reactor in the presence of a reforming catalyst and radiant heat transferred from the oxygen transport membrane reactor to produce a reformed synthesis gas stream comprising hydrogen and carbon monoxide;

treating the synthesis gas product stream in a separate high, medium and/or low temperature shift reactors to form a hydrogen-enriched synthesis gas stream; and
recovering a hydrogen product stream and a tail gas stream from the hydrogen-enriched synthesis gas stream utilizing a hydrogen PSA. No portion of the synthesis gas product stream from the reforming reactor is fed to the reactively driven and catalyst containing oxygen transport membrane reactor, allowing for higher ratios of H₂/CO in the syngas and for the reformers to be operated at higher pressures than otherwise possible with oxygen transport membrane based reforming systems.

### BRIEF DESCRIPTION OF THE DRAWINGS

While the specification concludes with claims distinctly pointing out the subject matter that applicants regard as their invention, it is believed that the invention will be better understood when taken in connection with the accompanying drawings in which:

FIG. 1 is a schematic illustration of an embodiment of an oxygen transport membrane (OTM) based reforming system, designed to carry out a reforming process and utilize the oxygen transport membrane reactor as heat source;

FIG. 2 is a schematic illustration of an embodiment of an oxygen transport membrane (OTM) based reforming system, designed to carry out a reforming process utilizing the oxygen transport membrane reactor as heat source, tailored for hydrogen production utilizing a water gas shift reactor and H₂ PSA;

FIG. 3 is a schematic illustration of an alternate embodiment of an oxygen transport membrane (OTM) based reforming system, designed to carry out a primary reforming process within the oxygen transport membrane reactor, tailored for hydrogen production utilizing high temperature water gas shift reactor, low temperature water gas shift reactor, and a H₂ PSA.

### DETAILED DESCRIPTION

The present invention relates to a method and system for producing hydrogen utilizing an oxygen transport membrane based reforming system. The system of the invention comprises at least two reactors in the form of sets of catalyst containing tubes:

a first set of tubes comprising at least one reforming catalyst containing reforming reactor configured to produce a synthesis gas stream, and

a second set of tubes comprising a reactively driven and catalyst containing oxygen transport membrane reactor configured to generate and radiate heat to the reforming reactor.

The method of the invention comprises:
separating oxygen from an oxygen containing stream with one or more oxidation catalyst containing oxygen transport membrane reactors to produce an oxygen permeate and an oxygen depleted retentate stream, the catalyst being contained within tubes on the permeate side of the oxygen transport membrane reactors;
feeding a fuel gas stream to a permeate side of the oxygen transport membrane elements and reacting same with the oxygen permeate to generate a reaction product stream and heat;
transferring the heat via convection to the oxygen depleted retentate stream and via radiation to said at least one catalyst containing reforming reactor;
reforming a combined feed stream comprising natural gas and steam in said at least one reforming reactor in the presence of a reforming catalyst and radiant heat transferred from the oxygen transport membrane reactor to produce a reformed synthesis gas stream comprising hydrogen and carbon monoxide;
treating the synthesis gas product stream in a separate high, medium and/or low temperature shift reactors to form a hydrogen-enriched synthesis gas stream; and
recovering a hydrogen product stream and a tail gas stream from the hydrogen-enriched synthesis gas stream utilizing a hydrogen PSA. No portion of the synthesis gas product stream from the reforming reactor is fed to the reactively driven and catalyst containing oxygen transport membrane reactor, allowing for higher ratios of H₂/CO in the
   syngas and for the reformers to be operated at higher pressures than otherwise possible with oxygen transport membrane based reforming systems.

In one embodiment, at least a portion of the fuel gas stream required for the oxygen transport membrane reactor is the tail gas stream from the hydrogen PSA, mixed with supplementary light hydrocarbon fuel such as natural gas. The heat generated as a result of the reaction of the fuel gas stream with permeated oxygen in the reactively driven and catalyst containing oxygen transport membrane reactor is transferred: (i) to the reforming reactor; (ii) to the unreformed fuel gas stream present in the reactively driven, catalyst containing oxygen transport membrane reactor; and (iii) to an oxygen depleted retentate stream. The oxygen transport membrane reactor can be configured to utilize all or a portion of the tail gas or a light hydrocarbon containing gas or mixtures thereof. Natural gas or any methane rich gas can be used as a source of the hydrocarbon containing feed stream.

A distinctive feature of the oxygen transport membrane based reforming system of the invention is that no portion of the synthesis gas product stream from the reforming reactor is fed to the reactively driven and catalyst containing oxygen transport membrane reactor. Consequently, the pressure of the syngas leaving the oxygen transport membrane based reforming system is not limited by the operating pressure of the reactively driven and catalyst containing oxygen transport membrane reactor. This distinctive feature allows for syngas generation with higher ratios of H₂/CO and for the reformers to be operated at higher pressures than normally possible, for e.g., from about 10 bar (145 psig) to about 35 bar (507 psig), in another embodiment from about 12 bar (175 psig) to about 30 bar (435 psig). The H₂/CO ratio of the final synthesis gas product produced in the described embodiment is typically from about 2.8 to 5.0. At these pressures hydrogen can be made without the need for a compressor, which is required in configurations that conduct secondary reforming in the OTM reactors. Additionally, the OTM reactors can be operated a lower pressures, as low as 25 psig, which can ultimately extend membrane life.

The invention may also be characterized as an oxygen transport membrane based hydrogen production system comprising: (a) an oxygen transport membrane based reactor housing containing: a reforming reactor disposed in the reactor unit and configured to reform a hydrocarbon containing feed stream in the presence of a reforming catalyst disposed in the reforming reactor and heat to produce a reformed synthesis gas stream; and a reactively driven and catalyst containing oxygen transport membrane reactor disposed in the reactor housing proximate the reforming reactor and configured to receive a hydrogen, carbon monoxide and light hydrocarbon containing fuel gas stream and react a portion of the fuel gas stream with permeated oxygen and generate a reaction product and heat, including the heat required by the reforming reactor, wherein the reactively driven, catalyst containing oxygen transport membrane reactor is further configured to reform any unreformed hydrocarbon gas in the fuel gas stream in the presence of reforming catalyst, some of the heat and permeated oxygen to produce a partially oxidized fuel gas stream; (b) a water gas shift reactor unit containing a high temperature water gas shift reactor; and (c) a hydrogen PSA unit. The reactively driven and catalyst containing oxygen transport membrane reactor can be configured to utilize all or a portion of the tail gas or a portion of the synthesis gas product or a light hydrocarbon containing gas or mixtures thereof.

The composition of the synthesis gas product stream depends on several factors including the steam to carbon ratio in the reforming reactor feed, temperature at the exit of the reforming reactor, and the heat transferred from the reactively driven catalyst containing oxygen transport membrane reactor to facilitate endothermic reforming reactions in the reforming reactor. Methane content of the synthesis gas product stream depends on the operating pressure of the reforming reactor and on the S/C ratio of the mixed feed. At a temperature of about 875° C. at the exit of the reforming reactor, operating pressures of about 13 bar (180 psig) and S/C ratio of 3.0, the synthesis gas product stream has a H₂/CO ratio of about 4.5 and methane content of about 2.8 mol % (dry basis). If the operating pressure is increased to about 34 bar (480 psig), the synthesis gas product stream has a H2/CO ratio of about 5.0 and methane content of about 7.5 mole % (dry basis).

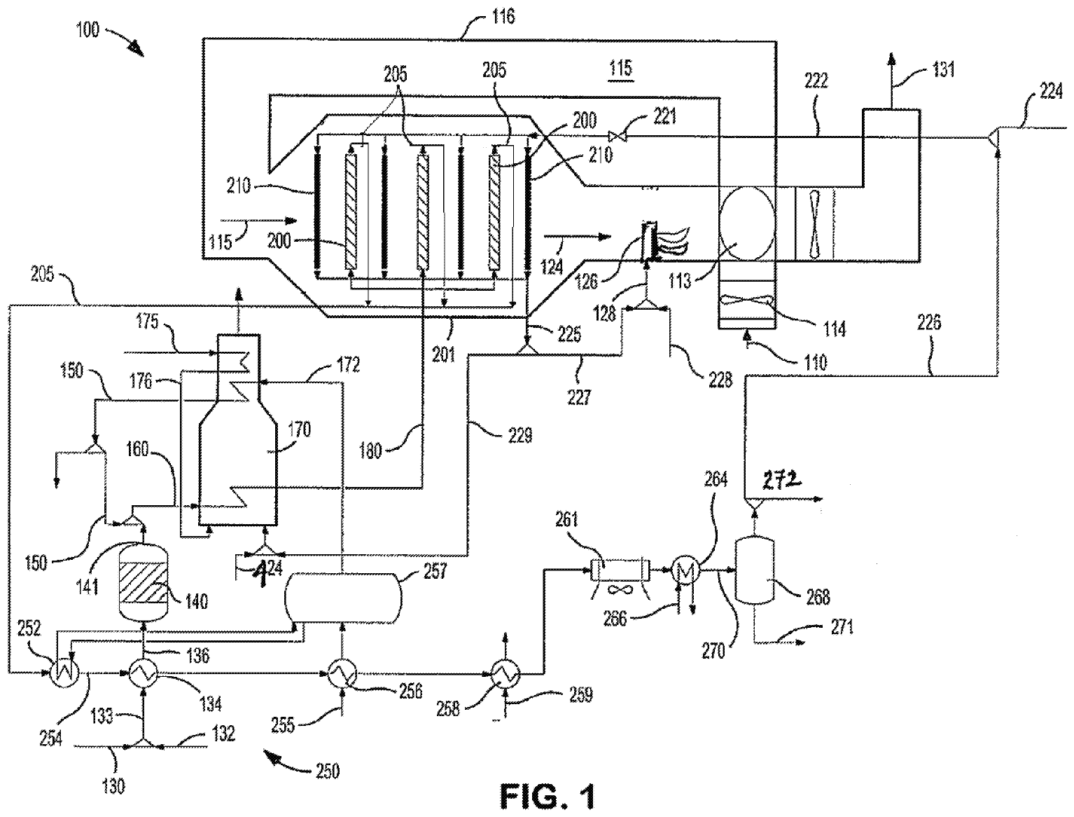

FIG. 1 provides a schematic illustration of an embodiment of an oxygen transport membrane based reforming system 100 in accordance with the present invention. As seen therein, an oxygen containing stream 110, such as air, is introduced to the system by means of a forced draft (FD) fan 114 into a heat exchanger 113 for purposes of preheating the oxygen containing feed stream 110. Heat exchanger 113 is preferably a high efficiency, cyclic and continuously rotating ceramic regenerator disposed in operative association with the oxygen containing feed stream 110 and a heated oxygen depleted retentate stream 124. The incoming air feed stream 110 is heated in the ceramic regenerator 113 to a temperature in the range of about 850° C. to 1050° C. to produce a heated air feed stream 115.

The oxygen depleted air leaves the oxygen transport membrane reforming tubes as heated oxygen depleted retentate stream 124 at the same or slightly higher temperature than the heated air feed stream 115. Any temperature increase, typically less than about 30° C., is attributable to the portion of energy generated by oxidizing reaction of hydrogen and carbon monoxide in the oxygen transport membrane tubes and transferred by convection to the oxygen depleted retentate stream 124.

This oxygen depleted retentate stream 124 is heated back to a temperature of from about 1050° C. to about 1200° C. prior to being directed to the heat exchanger or ceramic regenerator 113. This increase in temperature of the oxygen depleted retentate stream 124 is preferably accomplished by use of a duct burner 126, which facilitates combustion of a fuel stream 128 using some of the residual oxygen in the retentate stream 124 as the oxidant. Though not shown, an alternative means is to combust the fuel stream 128 with a separate air stream in a conventional burner and then mix the hot flue gas with the oxygen depleted retentate stream 124. In the ceramic heat exchanger or regenerator 113, the heated, oxygen depleted retentate stream 124 provides the energy to raise the temperature of the incoming feed air stream 110 from ambient temperature to a temperature from about 850° C. to about 1050° C. The resulting cold retentate stream exiting the ceramic heat exchanger, typically containing less than about 5% oxygen, leaves the oxygen transport membrane based reforming system 100 system as exhaust gas 131 at a temperature of around 150° C.

Although not shown in FIG. 1, an alternate embodiment of the oxygen transport membrane based reforming system 100 could dispose the duct burner and fuel stream upstream of the reactors in intake duct 116. Such arrangement would allow use of a smaller regenerator 113, less severe operating conditions for the regenerator 113 and possibly enable the regenerator to be built with cheaper materials.

The hydrocarbon containing feed stream 130, preferably natural gas, to be reformed is typically mixed with a small amount of hydrogen or hydrogen-rich gas 132 to form a combined hydrocarbon feed 133 and then preheated to around 370° C. in heat exchanger 134 that serves as a feed preheater, as described in more detail below. Since natural gas typically contains unacceptably high level of sulfur species, the hydrogen or hydrogen-rich gas 132 is added to facilitate desulfurization. Preferably, the heated feed stream 136 undergoes a sulfur removal process via device 140 such as hydro-treating to reduce the sulfur species to H₂S, which is subsequently removed in a guard bed (not shown) using material like ZnO and/or CuO. The hydro-treating step also saturates any alkenes present in the hydrocarbon containing feed stream. Further, since natural gas generally contains higher hydrocarbons that will break down at high temperatures to form unwanted carbon deposits that adversely impact the reforming process, the natural gas feed stream is preferably pre-reformed in an adiabatic pre-reformer (not shown), which converts higher hydrocarbons to methane, hydrogen, carbon monoxide, and carbon dioxide. Also contemplated but not shown is an embodiment where the pre-reformer is a heated pre-reformer that may be thermally coupled with oxygen transport membrane based reforming system.

Superheated steam 150 is added to the desulfurized hydrocarbon feed stream 141, as required, to produce a mixed feed stream 160 with a steam to carbon ratio from about 1.0 to about 3.0, and more preferably from about 1.5 to about 3.0. The superheated steam 150 is preferably at a pressure from about 15 bar to about 80 bar and at a temperature from about 300° C. to about 600° C. and generated in a fired heater 170 using a source of process steam 172. As seen in FIG. 1, the fired heater 170 is configured to combust a fuel stream 424 and a portion of the off-gas 229 produced by the oxygen transport membrane based reforming system using air 175 as the oxidant to heat the process steam 172 to superheated steam 150. In the illustrated embodiment, a source of air 175 is heated in the fired heater 170 to produce a heated air stream 176 to be used as the oxidant in the fired heated 170. The mixed feed stream 160 is also heated in the fired heater 170 producing a heated mixed feed stream 180. The heated mixed feed stream 180 has a temperature preferably from about 450° C. to about 650° C. and more preferably a temperature from about 500° C. to about 600° C. Alternatively, the steam superheater and mixed feed heater could be disposed in the duct downstream from the OTM reforming reactor and utilize oxygen depleted air stream 124 as heat source (not shown).

The illustrated embodiment of the oxygen transport membrane based reforming system 100 comprises two reactors (200, 210) disposed in a single reactor housing 201. The first reactor is a reforming reactor 200 which comprises reforming catalyst containing tubes configured to reform the heated mixed feed stream 180 containing a hydrocarbon feed and steam in the presence of a conventional reforming catalyst disposed in the reforming tubes and heat to produce a reformed synthesis gas stream 205. The temperature of the reformed hydrogen-rich synthesis gas stream 205 is typically designed to be from about 650° C. to about 900° C., and more preferably about 870 and 900° C. A distinctive feature of this oxygen transport membrane based reforming system 100 is that no portion of the syngas stream 205 is fed to the oxygen transport membrane reactor 210. Consequently, the pressure of the synthesis gas stream 205 leaving the reforming reactor 100 is not limited by the operating pressure of the oxygen transport membrane reactor 210. Generally, the pressure of the synthesis gas stream leaving the reforming reactor is greater than about 200 psig up to about 510 psig, in another embodiment greater than about 250 psig up to about 510 psig, and in another embodiment greater than about 300 psig up to about 510 psig. The synthesis gas stream 205 primarily contains hydrogen, carbon monoxide, carbon dioxide, steam and unconverted methane. H₂/CO ratio of the synthesis gas stream 205 is typically from about 2.8 to 5.0, in another embodiment from about 2.8 to about 5.0, in another embodiment from about 3.0 to 5.0, in another embodiment from about 3.5 to 5, and in yet another embodiment from about 4.7 to about 5. Methane content of synthesis gas stream 205 depends on the operating pressure of the reforming reactor 200 and on the S/C ratio of the mixed feed 180. At operating pressures of about 200 psig and S/C ratio of 3, methane content of synthesis gas stream 205 is about 1.9 mol % (dry basis).

The second reactor in the illustrated embodiment is an oxygen transport membrane reactor 210 that is configured to provide a source of radiant heat to the reforming reactor 200. The oxygen transport membrane reactor 210 is a reactively driven oxygen transport membrane reactor that comprises a plurality of oxygen transport membrane elements or tubes disposed proximate to or in a juxtaposed orientation with respect to the reforming reactor 200. The oxygen transport membrane reactor 210 is configured to separate or permeate oxygen from the oxygen containing stream 115 contacting the oxidant side of the oxygen transport membrane elements or tubes to the reactant side of the oxygen transport membrane elements or tubes through oxygen ion transport. The permeated oxygen reacts with a hydrogen containing stream 222, at a pressure that ranges from about 2 bar (29 psig) to about 12 bar (175 psig), in another embodiment from about a pressure ranging from about 2 bar (29 psig) to about 3 bar (32 psig), on the reactant side of the oxygen transport membrane elements or tubes to produce the difference in oxygen partial pressure across the oxygen transport membrane element and to produce a reaction product stream 225 and heat.

In the illustrated embodiment, the low pressure hydrogen containing stream 222 is a hydrogen and light hydrocarbon containing stream that preferably includes a recirculated portion 226 of the synthesis gas product stream and optionally a light hydrocarbon containing gas 224. A portion of the reaction product stream 225 exiting the reactant side of the oxygen transport membrane elements or tubes of the oxygen transport membrane reactor 210 is an off-gas 227 that may be mixed with a supplementary natural gas fuel 228 to the duct burner 126. Another portion of the reaction product stream 225 exiting the reactant side of the oxygen transport membrane elements or tubes is an off-gas 229 that may be mixed with a supplementary natural gas fuel 124 to fired heater 170. Alternatively, the reaction product stream 225 may be directly blended with air stream 124 by replacing a portion of the oxygen transport membrane elements or tubes that form the oxygen transport membrane reactor 210 with porous ceramic tubes that allow reaction product stream 225 to diffuse into the depleted air stream 124 (not shown).

Preferably, the reforming reactor 200 and the oxygen transport membrane reactor 210 are arranged as sets of closely packed tubes in close proximity to one another. The tubes in reforming reactor 200 generally contain reforming catalyst. Oxygen transport membrane reactor 210 comprises a plurality of ceramic oxygen transport membrane tubes. The oxygen transport membrane tubes are preferably configured as multilayered ceramic tubes capable of conducting oxygen ions at an elevated operational temperature, wherein the oxidant side of the oxygen transport membrane tubes is the exterior surface of the ceramic tubes exposed to the heated oxygen containing stream and the reactant side or permeate side is the interior surface of the ceramic tubes. Within each of the oxygen transport membrane tubes are one or more catalysts that facilitate partial oxidation and/or reforming, as applicable. Although only three of the reforming tubes are illustrated in FIG. 1 in close proximity to four of the reforming oxygen transport membrane elements or tubes, there could be many of such oxygen transport membrane tubes and many reforming tubes in each oxygen transport membrane based reforming sub-system or assembly as would occur to those skilled in the art. Likewise, there could be multiple oxygen transport membrane based reforming sub-systems or assemblies used in industrial applications of the oxygen transport membrane based reforming system 100.

The oxygen transport membrane elements or tubes used in the embodiments disclosed herein preferably comprise a composite structure that incorporates a dense layer, a porous support and an intermediate porous layer located between the dense layer and the porous support. Each of the dense layer and the intermediate porous layer are capable of conducting oxygen ions and electrons at elevated operational temperatures to separate the oxygen from the incoming air stream. The porous support layer would thus form the reactant side or permeate side. The dense layer and the intermediate porous layer preferably comprise a mixture of an ionic conductive material and an electrically conductive material to conduct oxygen ions and electrons, respectively. The intermediate porous layer preferably has a lower permeability and a smaller average pore size than the porous support layer to distribute the oxygen separated by the dense layer towards the porous support layer. The preferred oxygen transport membrane tubes also include a mixed phase oxygen ion conducting dense ceramic separation layer comprising a mixture of a zirconia based oxygen ion conducting phase and a predominantly electronic conducting perovskite phase. This thin, dense separation layer is implemented on the thicker inert, porous support.

Oxidation catalyst particles or a solution containing precursors of the oxidation catalyst particles are optionally located in the intermediate porous layer and/or in the thicker inert, porous support adjacent to the intermediate porous layer. The oxidation catalyst particles contain an oxidation catalyst, such as gadolinium doped ceria, which are selected to promote oxidation of the partially reformed synthesis gas stream in the presence of the permeated oxygen when introduced into the pores of the porous support, on a side thereof opposite to the intermediate porous layer.

The endothermic heating requirements of the reforming process occurring in the reforming reactor 200 are supplied through radiation of some of the heat from the oxygen transport membrane reactor 210 together with the convective heat transfer provided by heated oxygen depleted retentate stream. Sufficient thermal coupling or heat transfer between the heat-releasing ceramic oxygen transport membrane tubes and the heat-absorbing catalyst containing reformer tubes must be enabled within the design of the present reforming system. A portion of the heat transfer between the ceramic oxygen transport membrane tubes and the adjacent or juxtaposed reforming catalyst containing reformer tubes is through the radiation mode of heat transfer whereby surface area, surface view factor, surface emissivity, and non-linear temperature difference between the tubes (e.g., Tₒₜₘ⁴-T_{reformer}⁴), are critical elements to achieve the desired thermal coupling. Surface emissivity and temperatures are generally dictated by tube material and reaction requirements. The surface area and surface view factor are generally dictated by tube arrangement or configuration within each module and the entire reactor. While there are numerous tube arrangements or configurations that could meet the thermal coupling requirements between the oxygen transport membrane tubes and the reformer tubes, a key challenge is to achieve a relatively high production rate per unit volume which, in turn, depends on the amount of active oxygen transport membrane area contained within the unit volume. An additional challenge to achieving the optimum thermal coupling performance is to optimize the size of the ceramic oxygen transport membrane tubes and the catalyst containing reformer tubes, and more particular the effective surface area ratio, A_{reformer}/Aₒₜₘ, of the respective tubes. Of course, such performance optimization must be balanced against the manufacturability requirements, costs, as well as the reliability, maintainability, operating availability of the modules and reactor.

The synthesis gas stream 205 produced by the reforming reactor 200 generally contains hydrogen, carbon monoxide, residual unconverted methane, steam, carbon dioxide and other constituents. A significant portion of the sensible heat from the synthesis gas stream 205 can be recovered using a heat exchange section or recovery train 250. Heat exchange section 250 is designed to cool the produced synthesis gas stream 205 exiting the reforming reactor 200. In this illustrated embodiment, the heat exchange section 250 is also designed such that in cooling the synthesis gas stream 205, process steam 172 is generated, the combined hydrocarbon feed stream 133 is preheated, and boiler feed water 255 and feed water 259 are heated.

To minimize metal dusting issues, the hot synthesis gas product stream 205, preferably at a temperature of from about 800° C. to about 900° C. is cooled to a temperature of about 400° C. or less in a Process Gas (PG) Boiler 252. The initially cooled synthesis gas product stream 254 is then used to preheat the combined hydrocarbon feed stream 133 in a feed preheater 134 and subsequently to preheat boiler feed water 255 in the economizer 256 and to heat the feed water stream 259 in feed water heater 258. In the illustrated embodiment, the boiler feed water stream 255 is preferably pumped using a feed water pump (not shown), heated in economizer 256 and sent to steam drum 257 while the heated feed water stream is sent to a de-aerator (not shown) that provides boiler feed water 255. Synthesis gas leaving the feed water heater 258 is preferably around 150° C. It is cooled down to about 40° C. using a fin-fan cooler 261 and a synthesis gas cooler 264 fed by cooling water 266. The cooled synthesis gas 270 then enters a knock-out drum 268 where water is removed from the bottoms as process condensate stream 271 which, although not shown, is recycled for use as feed water, and the cooled synthesis gas 272 is recovered overhead.

A portion of the cooled synthesis gas stream 226 may optionally be recirculated to the reactor housing to form all or part of the low pressure hydrogen containing stream 222. Depending on the pressures of the reforming reactor 200, pressure of the recovered synthesis gas generally ranges from about 10 bar (145 psig) to about 35 bar (507 psig), in another embodiment from about 12 bar (175 psig) to about 30 bar (435 psig). The H₂/CO ratio of the final synthesis gas product produced in the described embodiment is typically from about 3.5 to 5.0.

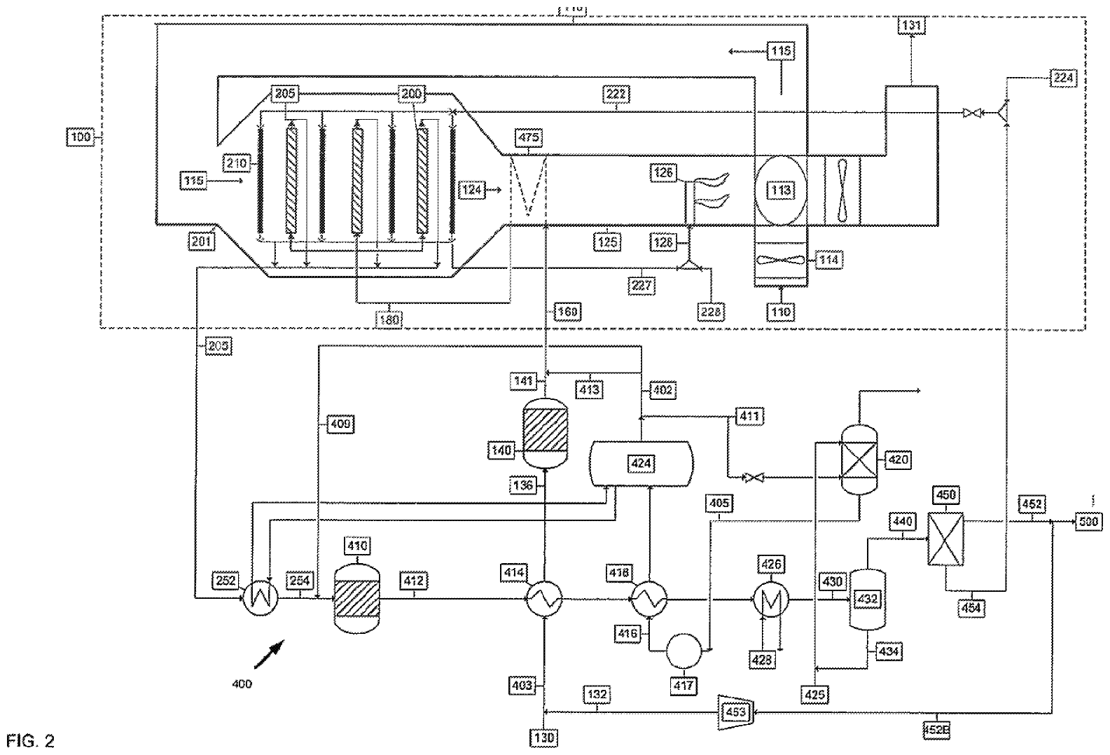

FIG. 2 is a schematic illustration of the oxygen transport membrane based reforming system of FIG. 1 tailored for and integrated with a hydrogen production process. In many regards, this embodiment is similar to the embodiment of FIG. 1 and, for sake of brevity, the description of the common aspects of the two embodiments will not be repeated here, rather, the following discussion shall focus on the differences.

A significant portion of the sensible heat from the synthesis gas stream 205 can be recovered using a downstream heat recovery and hydrogen recovery section 400 which is designed to both cool the produced synthesis gas stream 205 exiting the reforming reactor 200 and produce a hydrogen product 500. In the embodiment of FIG. 2, the heat recovery and hydrogen recovery section 400 is also designed such that in cooling the synthesis gas stream 205, the combined hydrocarbon feed stream 403 is preheated, process steam 402 is generated, and boiler feed water 405 is also heated. As with the previously described embodiments, the hot synthesis gas product stream 205, preferably at a temperature between about 800° C. and 900° C. is cooled to a temperature of about 400° C. or less in a Process Gas (PG) Boiler 252. Steam 409 is added to the initially cooled synthesis gas product stream 254 which is then directed to a high temperature shift reactor 410 to generate additional hydrogen via the Water Gas Shift reaction:

CO+H₂O→CO₂+H₂

Alternatively, the inlet temperature to the high temperature shift reactor 410 can be controlled by adding superheated steam (not shown) to the initially cooled synthesis gas product stream 254 ahead of entering the high temperature shift reactor 410. In the high temperature shift reactor 410, from about 20 to about 30% of the carbon monoxide is reacted to produce the hydrogen rich synthesis gas stream 412 containing from about 50 to about 60% molar hydrogen and having a H₂/CO ratio of from about 3.5 to about 21, in another embodiment from about 5 to about 20. Since the Water Gas Shift reaction is exothermic, the shifted synthesis gas stream 412 leaving the high temperature shift reactor 410 is at a temperature greater than the directly cooled synthesis gas product stream 254, and typically at a temperature of around 435° C. A portion of the sensible energy in this shifted synthesis gas 412 stream is then recovered by sequentially heating the combined hydrocarbon feed stream 403 in a feed preheater 414 and then preheating boiler feed water stream 416 in economizer 418. In the illustrated embodiment, the boiler feed water stream 416 is preferably pumped using a feed water pump 417, heated in economizer 418 and sent to steam drum 424 while make-up water stream 425 and steam 411 are sent to a de-aerator 420 that provides the boiler feed water 405. Shifted synthesis gas leaving the economizer 418 is then cooled down to about 38° C. using a synthesis gas cooler 426 fed by a source of cooling water 428. The cooled synthesis gas 430 then enters a knock-out drum 432 used to remove moisture as a condensate stream 434 which is recycled for use as feed water, and the cooled shifted synthesis gas 440 is recovered overhead. Steam from steam drum 424 is: (i) used by the de-aerator 420; (ii) added to the desulfurized hydrocarbon feed stream 141; (iii) added to the initially cooled synthesis gas stream 254 upstream of the shift reactor 410; and (iv) exported. In small hydrogen production plants, such as shown in FIG. 2, it may be preferable to design the plant for little to no steam export. If there is excess steam that cannot be exported, it can be mixed with the shifted synthesis gas leaving the economizer 418 as quench steam and condensed in the synthesis gas cooler 426 or using a fin-fan cooler (not shown). When excess steam is required or desirable in larger hydrogen production plants, such steam can be made available by adding steam generation capabilities into a separate fired heater, similar to the fired heater arrangement in FIG. 1, or by adding a flue gas boiler disposed in the retentate duct 125 of the oxygen transport membrane based reforming system downstream of the reactor housing (not shown).

The cooled shifted synthesis gas stream 440 is then directed to a hydrogen pressure swing adsorption (H₂ PSA) unit 450 which produces a hydrogen gas stream 452 and a tail gas 454, which contains about 30% hydrogen, about 50% carbon dioxide and from about 10 to about 20% carbon monoxide and trace amounts of unreacted methane (<1%). A portion of the hydrogen gas becomes the hydrogen product 500 and the rest of the hydrogen gas 452B is directed to a hydrogen recycle compressor 453 and mixed with the natural gas feed 130 prior to desulfurization and reforming to produce the combined hydrocarbon feed stream 403. Depending on the operating pressures of the based reforming reactor 200, pressure of the hydrogen product generally ranges from about 10 bar (145 psig) to about 35 bar (507 psig), in another embodiment from about 12 bar (175 psig) to about 30 bar (435 psig). A portion or all of the tail gas 454 is directed to the oxygen transport membrane reactor 210 and mixed with a light hydrocarbon containing gas 224 to form part or all of the hydrogen containing stream 222. All or a portion of the tail gas 454 could constitute all or a portion of the fuel stream 128 feeding the duct burner 126.

Dry syngas is fed to a H₂ Pressure Swing Adsorption (PSA) unit, which generates high purity (>99.99%) H₂. As mentioned above, the other species are recovered in the PSA tail gas. In one specific example, composition of the PSA tail gas, on a molar basis, was 4.4% CH₄, 9.5% CO, 44.1% CO₂, 40.1% H₂, 0.5% N₂, 1.4% H₂O. To achieve a H₂ recovery of about 80%, it is recommended that the minimum pressure of the dry syngas feeding the H₂ PSA be at least 180 psia. The PSA tail gas 454 is typically recovered at a pressure of about 5 psig and mixed with some NG 224 and sent to the OTM tubes 210 in the OTM reactor. Higher heating value of the PSA tail gas 454 is generally about 300 Btu/scf. About 60% of the incoming H₂ & CO is combusted in the OTM tubes 210. The OTM tubes 210 generally contain catalyst to facilitate reforming of methane in the fuel stream 222. The exhaust 227 from the OTM tubes 210 has some residual heating value (40-100 Btu/scf) and can be used as fuel in the duct burner 126. If necessary, some NG 228 can be added to the duct burner 126 to increase the heating value of the fuel stream 128.

The configuration shown in FIG. 2 is typically representative of small H₂ plants producing less than 10 MMSCFD of H2. Typically for such plants, there may not be a user of the excess steam. Process conditions can be adjusted to eliminate steam export. Furthermore, it is desirable to minimize the capital cost of such small H2 plants. Accordingly, the configuration in FIG. 2 has been optimized to minimize the number of distinct pieces of equipment. Those skilled in the art would recognize that several variations are possible, e.g. first cooling the syngas in a fin-fan air cooler to about 70° C. before feeding the cooling water based syngas cooler; use of a de-aerator to maintain water quality.

Another difference between the embodiment of FIG. 1 and the embodiment shown in FIG. 2 relates to the steam handling and heating of the mixed feed stream 160. As indicated above, a portion of the steam 411 from steam drum 424 is used by the de-aerator 420 while a second portion of the steam 409 is added to the initially cooled synthesis gas stream 254 upstream of the shift reactor 410. Yet another portion of the steam 413 may be added to the desulfurized hydrocarbon feed stream which is then heated to a temperature preferably from about 475° C. to about 650° C., and more preferably to a temperature from about 520° C. to about 600° C. by means of indirect heat exchange with the heated oxygen depleted retentate stream using steam coils 475 disposed in the retentate duct 125 of the oxygen transport membrane based reforming system downstream of the reactor housing.

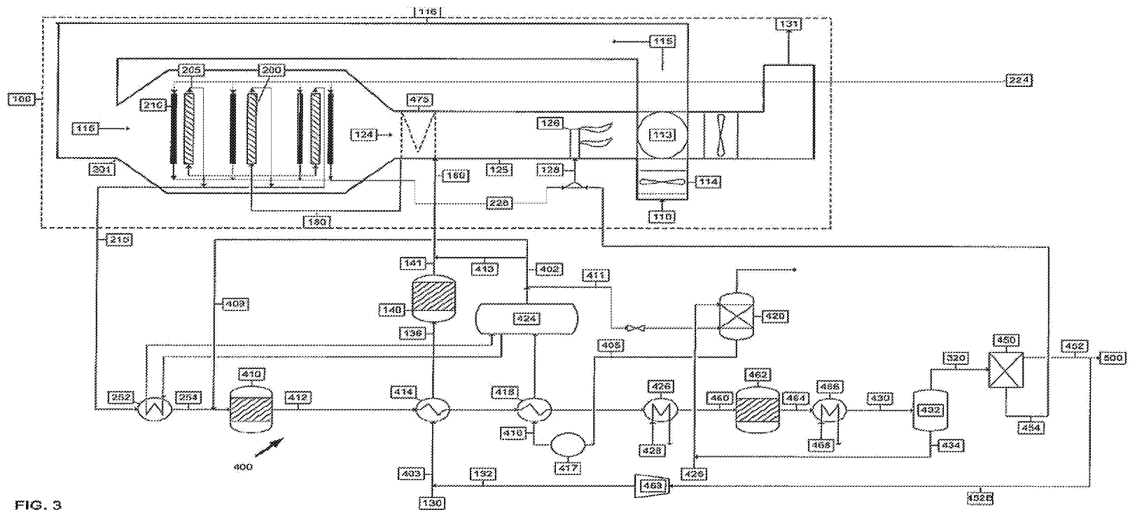

An alternate embodiment is shown in FIG. 3. In many regards, this embodiment is similar to the embodiment of FIG. 2 and thus the description of the common aspects of the two will not be repeated here. The difference between the embodiments shown in FIGS. 2 and 3 is the addition of a low temperature shift reactor 462 in FIG. 3. This low temperature shift reactor 462 is added to the system to increase the conversion of carbon monoxide and produce more hydrogen, therefore reducing the amount of tail gas 454 and increasing the conversion efficiency (i.e. BTU of NG (hydrocarbon feed) per SCF of hydrogen produced) of the system. The addition of the low temperature shift reactor 462 improves the efficiency (BTU/SCF of hydrogen produced) by up to about 25%. In the embodiment shown in FIG. 3, the cooled synthesis gas 460 enters the low temperature shift reactor 462 at about 160° C. where most of the remaining carbon monoxide, typically greater than 80% and preferably greater than 95% is reacted with water to produce more hydrogen and carbon dioxide, resulting in a synthesis gas stream 464 with a H₂/CO ratio higher than about 370 and less than 1% molar of carbon monoxide. The synthesis gas stream 464 leaves the low temperature shift reactor 462 at about 190° C. and is then cooled down to about 38° C. using a synthesis gas cooler 466 fed by a source of cooling water 468. The cooled shifted synthesis gas stream 430 then enters a knock-out drum 432 used to remove moisture as condensate stream 434 which is recycled for use as feed water, and the cooled shifted synthesis gas 320 is recovered overhead and sent to the H₂ PSA 450. Because of the addition of the low temperature shift reactor 462, the tail gas 454 composition is different from the previous embodiment, containing up to about 70% carbon dioxide and only trace amounts of carbon monoxide and methane (<1%).

It is recognized that the embodiments presented in FIGS. 2 and 3 can also be used to co-produce syngas and hydrogen. In this case, only the portion of synthesis gas for hydrogen production is subject to water gas shift reactions at high and optionally low temperatures. This shifted syngas is sent to a H₂ PSA unit which produces a hydrogen gas product and a tail gas. The rest of the synthesis gas product is cooled and conditioned for subsequent use in end applications including synthesis of chemicals and liquid fuels.

While the present invention has been characterized in various ways and described in relation to preferred embodiments, as will occur to those skilled in the art, numerous, additions, changes and modifications thereto can be made without departing from the spirit and scope of the present invention as set forth in the appended claims.

What is claimed is:

1. A method for hydrogen production utilizing an oxygen transport membrane based reforming system, wherein said system comprises at least one reforming reactor and at least one oxygen transport membrane reactor in close proximity to said at least one reforming reactor, the method comprising the steps of:
separating oxygen from an oxygen containing stream with one or more catalyst containing oxygen transport membrane reactors to produce an oxygen permeate and an oxygen depleted retentate stream, the catalyst being contained within tubes on the permeate side of the oxygen transport membrane reactors;
feeding a fuel stream to a permeate side of the oxygen transport membrane elements and reacting same with the oxygen permeate to generate a reaction product stream and heat;
transferring the heat via convection to the oxygen depleted retentate stream and via radiation to at least one catalyst containing reforming reactor configured to produce a synthesis gas stream;
reforming a combined feed stream comprising natural gas and steam in said at least one reforming reactor in the presence of a reforming catalyst and radiant heat transferred from the oxygen transport membrane reactor to produce a reformed synthesis gas stream comprising hydrogen and carbon monoxide;
treating the synthesis gas product stream in a separate high, medium and/or low temperature shift reactor to form a hydrogen-enriched synthesis gas stream; and
treating the hydrogen-enriched synthesis gas stream in a hydrogen PSA; and
recovering a hydrogen product stream and a tail gas stream;
wherein a portion of the fuel gas stream required for the oxygen transport membrane reactor is the tail gas stream from the hydrogen PSA, mixed with supplementary hydrocarbon fuel, and wherein no portion of the reformed synthesis gas stream leaving the reforming reactor is recycled back to the oxygen transport membrane reactor.

2. The method of claim 1 wherein the heat generated as a result of the reaction of the fuel stream with permeated oxygen is transferred: (i) to the reforming reactor; (ii) to the unreformed fuel gas stream present in the reactively driven, catalyst containing oxygen transport membrane reactor; and (iii) to an oxygen depleted retentate stream.

3. The method of claim 1 wherein the pressure of the synthesis gas stream leaving the reforming reactor is greater than about 200 psig up to about 510 psig.

4. The method of claim 1 wherein the pressure of the synthesis gas stream leaving the reforming reactor is greater than about 250 psig up to about 510 psig.

5. The method of claim 1 further comprising the step of reheating the oxygen depleted stream to a temperature of from about 1050° C. to about 1200° C. using a burner disposed within or proximate to the oxygen transport membrane based reforming system, where the burner is configured to combust a fuel stream to heat the incoming oxygen containing stream via indirect heat exchange.

6. The method of claim 1 wherein the hydrogen to carbon monoxide ratio (H₂/CO) of the synthesis gas product stream is greater than 2.8 and is dependent on the reforming temperature and the amount of heat supplied to the reforming reactor the oxygen transport membrane reactors.

7. The method of claim 1 wherein the H₂/CO ratio of the final synthesis gas product produced ranges from about 3.00 to about 5.00.

8. A hydrogen production system comprising:
an oxygen transport membrane based reactor housing comprising:
a reforming reactor disposed in the reactor housing and configured to reform a hydrocarbon containing feed stream in the presence of a reforming catalyst disposed in the reforming reactor and heat to produce a reformed synthesis gas stream;
a reactively driven, catalyst containing oxygen transport membrane reactor disposed in the reactor housing proximate the reforming reactor and configured to receive a hydrocarbon containing fuel stream and react said stream with permeated oxygen and generate a first reaction product and heat;
a water gas shift reactor unit; and
a hydrogen PSA unit,
wherein said reforming reactor is configures to produce synthesis gas at a pressure of greater than about 200 psig up to about 510 psig and no portion of said product synthesis gas is fed back to said oxygen transport membrane reactors.

9. The system of claim 8 wherein the reactively driven, catalyst containing oxygen transport membrane reactor further comprises a plurality of oxidation catalyst containing oxygen transport membrane tubes defining an oxidant side and a reactant side and configured to separate oxygen from an oxygen containing stream contacting the oxidant side and permeate separated oxygen to the reactant side through oxygen ion transport when subjected to the elevated operational temperature and the difference in oxygen partial pressure across the at least one oxygen transport membrane tube.

10. The system of claim 8 wherein the hydrogen to carbon monoxide ratio (H₂/CO) of the synthesis gas product stream is greater than 2.8 and is dependent on the reforming temperature.

11. A method for hydrogen production utilizing an oxygen transport membrane based reforming system, said system comprising at least one reforming reactor and at least one oxygen transport membrane reactor in close proximity to said at least one reforming reactor, the method comprising the steps of:
feeding a hydrocarbon containing feed stream to a reactant side of a reactively driven and catalyst containing oxygen transport membrane reactor,
wherein the oxygen transport membrane reactor includes at least one oxygen transport membrane element configured to separate oxygen from an oxygen containing stream at the oxidant side of the reactively driven and catalyst containing oxygen transport membrane reactor and permeate separated oxygen to the reactant side through oxygen ion transport when subjected to an elevated operational temperature and a difference in oxygen partial pressure across the at least one oxygen transport membrane element;
reacting said feed gas stream with oxygen permeated through the at least one oxygen transport membrane element to produce the difference in oxygen partial pressure across the at least one oxygen transport membrane element and generate reaction products and heat, including the heat required for the reforming of the hydrocarbon containing feed stream in the reforming reactor;
reforming a hydrocarbon containing feed stream in a reforming reactor in the presence of a reforming catalyst disposed in the reforming reactor and heat to produce a reformed synthesis gas stream comprising hydrogen, carbon monoxide, and unreformed hydrocarbon gas;
treating at least a portion of the synthesis gas product stream in a separate high temperature shift reactor followed by a low temperature shift reactor to form a hydrogen-rich synthesis gas stream; and
treating the hydrogen-rich synthesis gas stream in a hydrogen PSA and recovering a hydrogen product stream and a tail gas stream,
wherein the pressure of the synthesis gas stream leaving the reforming reactor is greater than about 200 psig up to about 515 psig, and wherein the H₂/CO ratio of the final synthesis gas product ranges from about 2.8 to 5.0, wherein no portion of said product syngas is recycled back to said oxygen transport membrane reactor.
